(19) United States
(12) Patent Application Publication
(10) Pub. No.: US 2006/0074713 A1
(43) Pub. Date: Apr. 6, 2006

(54) Patient identification card system and method for efficient medical care

(76) Inventors: Anne Marie Conry, Wauwatosa, WI (US); Gopal B. Avinash, New Berlin, WI (US)

Correspondence Address: MCANDREWS HELD & MALLOY, LTD, 500 WEST MADISON STREET, SUITE 3400, CHICAGO, IL, 60661, US

(21) Appl. No.: 10/958,105

(22) Filed: Oct. 4, 2004

(51) Int. Cl. G06Q 50/00

(52) U.S. Cl. 705/2

(57) ABSTRACT

A patient identification card system and method for efficient medical care. The present invention provides an improved patient identification card system for efficient medical care including a patient card, a patient card access device, and a medical report. The present invention also provides an improved patient identification card system for efficient medical care including a patient card, a physiologic sensor network, a patient card access device, and a data processor. The present invention also includes a method for obtaining patient information using a patient card including inputting a request to a data processor, processing the request with the data processor, and outputting the processed information to a medical report.

### BACKGROUND OF THE INVENTION

The present invention generally relates to a patient information system. More specifically, the present invention relates to a patient identification card system and method for efficient medical care.

Patient information typically includes, for example, information such as the patient's name, address, and contact information; insurance and billing information; the patient's primary care doctor and specialists; and current medication and allergy information. Providing this information repeatedly may be not only be time consuming, but also exasperating to the patient and discrepancies may be problematic for healthcare personnel.

In today's medical care environment, a patient must give their information multiple times throughout the treatment process. For example, arriving at the hospital emergency room, when checking-in for an appointment, getting a scan in the radiology department, or getting blood drawn at the lab, a patient must give their information each step of the way. This becomes an irritation to both the patient and the medical staff.

In addition, productivity and patient throughput are hindered. The need to constantly re-enter data at each step, a time consuming activity given the volume of data, significantly reduces the number of patients that may be processed, reducing productivity overall.

More importantly, repeatedly entering patient information occasionally leads to inaccuracies. For example, a patient's last name may be misspelled. This could cause the patient's records to be separated, misplacing valuable medical information.

Rapid access to complete and up-to-date patient information is convenient for increasing patient throughput by reducing the time needed for data entry. However, such rapid access is critical in emergencies, and current methods for obtaining this information are too slow and potentially incomplete or inaccurate. For example, a paramedic arriving on the scene of an accident or other situation filled with unknowns may benefit greatly from the ability to quickly retrieve patient information. This is particularly true when no one, including the patient, may be in a position to provide much of the information.

In addition, some patient information changes frequently. For example, heart rate and glucose levels. Current systems do not allow in-vivo monitoring of patient information via a physiologic sensor network and notification of potential problems.

Another problem with current systems is that medical care received at a facility outside the patient's insurance network often does not get associated with the bulk of the patient's medical records. Such medical care may be provided by an out-of-network provider at a patient's request. However, it may also occur in other situations. For example, when a person is on vacation, out of the area covered by their insurance company, and requires care. While some insurance companies have nationwide networks, a person could still easily find himself or herself in need of care in an area where there is no in-network provider.

Furthermore, a patient who moves from one network to another often does not have all of their records transferred with them. There is no easy and efficient method of transferring the patient's records to the new network under current systems. As a result, a patient's records may be incomplete.

Thus, a need exists for a patient identification card system and method for efficient medical care. Such a system and method may provide the conveniences of not having to manually enter patient information multiple times and improving hospital workflow and patient throughput. In addition, such a system and method may greatly reduce the potential for errors, including both data entry errors and patient omission errors. Such a system and method may also allow the integration of patient information from multiple sources, including both in-network and out-of-network healthcare providers, keeping the patient's medical records up-to-date. Further, such a system and method may provide monitoring and notification of changes in patient information.

### BRIEF SUMMARY OF THE INVENTION

The present invention provides an improved patient identification card system for efficient medical care. The system includes a patient card, a network database, and a patient card access device. The patient card is capable of storing and communicating patient information. The network database is capable of storing and communicating patient information. The patient card access device is capable of communicating with the patient card and/or the network database. The patient card access device is also capable of reading, writing, and/or updating patient information on the patient card and/or the network database.

The present invention also provides a method for obtaining patient information using a patient card. The method includes reading patient information and populating a medical report. The patient information is read from a patient card. The medical report is populated with the patient information.

The present invention also provides a method for improved patient care using a patient identification card. The method includes reading card patient information, reading database patient information, and updating a network database and/or a patient card. The patient card information is read from the patient card. The database patient information is read from the network database. When updated, the network database is updated with the card patient information. When updated, the patient card is updated with the database patient information.

The present invention also provides an improved patient identification card system for efficient medical care. The system includes a patient card, a patient access device, and a medical report. The patient card is capable of storing patient information. The patient card access device is capable of communicating with the patient card. The medical report is capable of being in communication with the patient card and/or the patient card access device. The system also includes a data processor. The data processor may be located in the patient card and/or the patient card access device. The patient card may be capable of reading, writing, and/or modifying the patient information. The patient card access device may be capable of reading, writing, and/or modifying the patient information. The patient card may populate the medical report based in part on the patient information. The patient card access device may populate the medical report based in part on the patient information. The patient card may be capable of populating the medical report using logic rules to resolve discrepancies in data field names. The patient card access device may be capable of populating the medical report using logic rules to resolve discrepancies in data field names.

The present invention also provides an improved patient identification card system for efficient medical care. The system includes a patient card, a physiologic sensor network, a patient card access device, and a data processor. The patient card is capable of storing and communicating patient information. The physiologic sensor network is capable of communicating with the patient card. The patient card access device is capable of communicating with the patient card. The data processor is capable of communicating with the patient card and/or the patient card access device. The patient card may be implanted. The patient card may store physiologic data communicated by the physiologic sensor network. The data processor may notify the patient card access device based in part on the physiologic data. The data processor may make a diagnostic recommendation based in part on the physiologic data. The patient card may include the data processor. The patient card access device may include the data processor. The data processor may populate a medical report based in part on the patient information. The data processor may populate the medical report using logic rules to resolve discrepancies in data field names.

The present invention also provides a method for obtaining patient information using a patient card. The method includes inputting a request to a data processor from a patient card access device, processing the request with the data processor based in part on patient information stored in a patient card, and outputting processed information from the data processor to a medical report.

These and other features of the present invention are discussed or apparent in the following detailed description.

### BRIEF DESCRIPTION OF THE DRAWINGS

FIG. 1 illustrates a system for patient identification cards for efficient medical care used in accordance with an embodiment of the present invention.

FIG. 2 illustrates a system for patient identification cards for efficient medical care used in accordance with an embodiment of the present invention.

FIG. 3 illustrates a flow diagram for a method for patient identification cards for efficient medical care used in accordance with an embodiment of the present invention.

FIG. 4 illustrates a system for patient identification cards for efficient medical care used in accordance with an embodiment of the present invention.

FIG. 5 illustrates a system for patient identification cards for efficient medical care used in accordance with an embodiment of the present invention.

FIG. 6 illustrates a flow diagram for obtaining patient information using a patient card used in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

The present invention relates to a system and method for patient identification cards for efficient medical care.

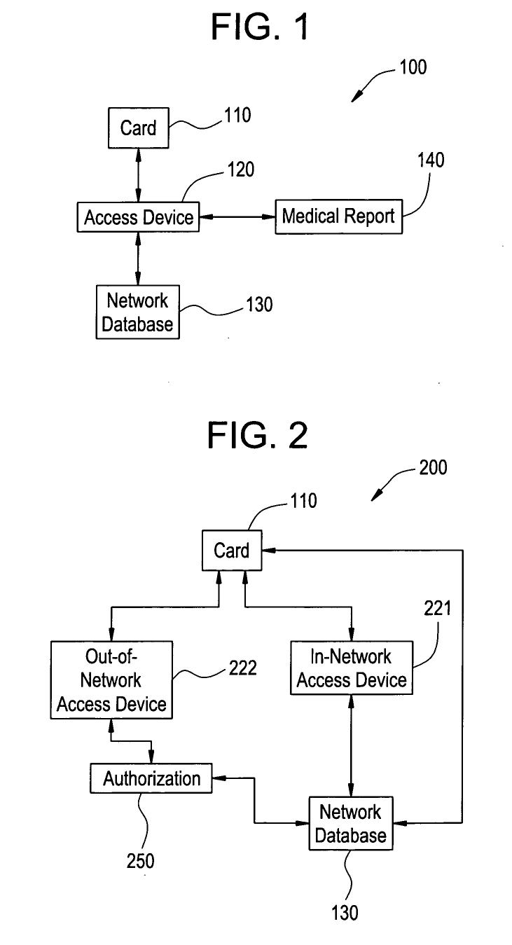

FIG. 1 illustrates a system 100 for patient identification cards for efficient medical care used in accordance with an embodiment of the present invention. The system 100 includes a patient card 110, a patient card access device 120, and a network database 130. The system may also include a medical report 140 in certain embodiments.

The access device 120 is capable of communication with the patient card 110. In addition, in certain embodiments, the access device 120 may be capable of communication with the network database 130. The access device 120 may also be capable of communication with the medical report 140.

In operation, the access device 120 may communicate with the patient card 110 to retrieve patient information stored in the patient card 110. The access device 120 may also communicate with the patient card 110 to store patient information in the patient card 110. The communication between the access device 120 and the patient card 110 may be one or more of reading, writing, and modifying (may also be referred to collectively as populating or updating) patient information on the patient card 110. In certain embodiments of the present invention, some or all of the personal information stored on the patient card may be read without authorization. In certain embodiments, no personal information stored on the patient card may be read without authorization. The authorization may be made by, for example, the patient or a medical administrator. Examples of personal information that may be accessed without authorization may include: patient name, address, patient contact information, and a patient identifier.

Patient information may include, for example, one or more of the following pieces of information: patient name, patient address, patient contact information, emergency contact information, insurance information, billing information, primary care doctor information, specialist information, drug information, allergy information, current medication information, and a patient identifier. Patient information may also include patient records and reports. In addition, patient information may also include, for example, biographical information, medical history, family history, genetic test results, blood test results, heart rate, blood pressure, blood flow, and biomarker presence information. The patient identifier may be unique, for example, within a network or globally. Blood test results may include, for example, test results for blood oxygen level, white blood cell count, T-cell count, complete blood count, thyroid, cardiac risk factors, cholesterol, proteins, PSA (prostate), waste products, and glucose. In certain embodiments of the present invention, patient information may come from multiple sources. For example, patient information may come from one or more of the patient, an insurance company, an in-network healthcare provider, and an out-of-network healthcare provider.

The access device 120 may communicate with the network database 130 to retrieve patient information stored in the network database 130. The access device 120 may also communicate with the network database 130 to store patient information in the network database 130. The communication between the access device 120 and the network database 130 may be one or more of reading, writing, and modifying patient information in the network database 130.

The access device 120 may read, write, and/or update patient information on one or both of the patient card 110 and the network database 130. For example, the access device 120 may update patient information on the patient card 110 based in part on patient information that was stored in the network database 130. As another example, the access device may write patient information to the patient card 110.

The access device 120 may also communicate with the medical report 140. The medical report 140 may contain patient information relating to, for example, a medical appointment or procedure, such as: a routine appointment, diagnostic scan, screening scan, lab work, or surgery. The communication between the access device 120 and the medical report 140 may be, for example, a digital or analog transfer of information between the access device 120 and the medical report 140.

As an example, the medical report 140 may be a software program running on a computer attached to the access device 120. The medical report 140 may include information such as patient information, coded patient information, descriptors, images, laboratory data, demographic data, histological data, and/or other patient-related data. The medical report 140 may be a structured and/or non-structured report.

Thus, the access device 120 may populate or update a medical report 140 with patient information, for example. The patient information may be based in part on patient information stored in, for example, the patient card 110 or the network database 130. The medical report 140 may be, for example, an existing medical report or a new medical report.

In certain embodiments of the present invention, the patient information in the medical report 140 may be added and/or changed by a person or device other than the access device 120 or patient card 110. For example, a nurse or physician may update the medical report 140 based on an examination of the patient. The access device 120 may then update the patient card 110 and/or the network database 130 based in part on these changes to the medical report 140.

The access device 120 and the patient card 110 may communicate by, for example, one or more of a barcode, magnetic strip, wireless communications device, portable storage device, and a smart card chip. The wireless communication device may be based on, for example, an infrared communications device, radio-frequency communications device, proximity card, or wireless networking. As an example, the radio-frequency communications device may be a radio-frequency identifier (RFID). The wireless networking may be, for example, an IEEE 802.11 wireless networking device or a Bluetooth® device. Examples of a portable storage device may include a device based on one or more of a flash memory key using a universal serial bus (USB) or IEEE 1394 (FireWire®) interface, a Memory Stick®, CompactFlash® card, or a portable hard drive.

The access device 120 may be located, for example, at a medical care facility, clinic check-in station, nurses' station, diagnostic imaging (DI) suite, admissions desk, ambulance, or emergency service vehicle. The access device may be, for example, an in-network or out-of-network access device at a hospital admissions desk. The access device 120 may be, for example, a desktop computer, a portable computer, a handheld computer, a scanner, and/or other processing device. For example, a portable computer access device 120 may be used by a paramedic to read patient information from a patient card 110 in a patient's home during an emergency.

The access device 120 and the network database 130 may communicate by, for example, a phone line, Internet, computer network, a satellite, a virtual private network, wireless network, or cellular network. The communication between the access device 120 and the network database 130 may be, for example, encrypted and/or protected by a password or other authentication mechanism. That is, an access device 120 may obtain authorization to communicate with the network database 130. Authorization may be automatically obtained, or the access device 120 may prompt a system or user for authorization, for example.

For the purposes of illustration only, certain embodiments are referred to as a patient card 110. The patient card 110 may be any of a number of devices. For example, in an embodiment of the present invention, the patient card 110 may be based on one or more of a thin, rectangular piece of plastic; a bracelet, ring, necklace, watch, or other piece of jewelry; and an implanted or wearable device. In an embodiment of the present invention, the patient card 110 may be, for example, a combination of one or more devices, such as: a personal digital assistant (PDA), handheld computer, portable computer, tablet computer, and cellular phone. As a further example, in an embodiment of the present invention, the patient card 110 may be capable of one or more of reading, writing, and modifying patient information stored in the patient card 110.

In an embodiment of the present invention, the patient card 110 may be attached to a key chain. In an embodiment of the present invention, the patient card 110 may be substantially the same size as a credit card. In an embodiment of the present invention, the patient card 110 may also be the insurance card of a patient. In an embodiment of the present invention, the patient card 110 may also include a patient photograph. In an embodiment of the present invention, the patient card 110 may also include information needed by the medical personnel if the user becomes incapacitated.

FIG. 2 illustrates a system 200 for patient identification cards for efficient medical care used in accordance with an embodiment of the present invention. The system 200 includes a patient card 110, an in-network access device 221, an out-of-network access device 222, and a network database 130. The system 200 may also include an authorization subsystem 250.

The in-network access device is capable of communication with the patient card 110. The out-of-network access device is capable of communication with the patient card 110. The in-network access device is capable of communication with the network database 130. The out-of-network access device may be capable of communication with the authorization subsystem 250. The authorization subsystem 250 is capable of communication with the network database 130. The patient card 110 may be capable of communication with the network database 130.

In operation, the in-network access device 221, similar to the access device 120, may communicate with the patient card 110, as described above. For example, the in-network access device 221 may do one or more of read, write, and update patient information on the patient card 110. In addition, the patient card 110 may, for example, store patient information from the in-network access device 221.

The in-network access device 221 may also communicate with the network database 130, as described above.

The out-of-network access device 222, similar to the access device 120, may communicate with the patient card 110, as described above. For example, the out-of-network access device 222 may do one or more of read, write, and update patient information on the patient card 110. In addition, the patient card 110 may, for example, store patient information from the out-of-network access device 222.

In an embodiment of the present invention, the out-of-network access device 222 may communicate with the authorization subsystem 250. Similar to the communication between an access device 120 and the network database 130, the communication between the out-of-network access device 222 and the authorization subsystem 250 may be by, for example, a phone line, Internet, computer network, a satellite, a virtual private network, wireless network, or cellular network. The communication between the out-of-network access device 120, 222 and the authorization subsystem 250 may be, for example, encrypted and/or protected by a password or other authentication mechanism. That is, an out-of-network access device 222 may obtain authorization to communicate with the network database 130. Authorization may be automatically obtained, or the out-of-network access device 222 may prompt a system or user for authorization, for example. The authorization subsystem 250 may also be separate from or may be integrated, in whole or part, into the access device 120, 222 and/or the network database 130.

The authorization subsystem 250 may permit an out-of-network access device 222 to read, write, and/or update patient information in the network database 130. The communication between the out-of-network access device 222 and the network database 130 may be permitted based at least in part on a level of access granted to a system or user being authorized. That is, for example, a nurse may only be authorized by the authorization subsystem 250 to read patient information from the network database 130. As another example, a physician may be authorized by the authorization subsystem 250 to read, write and/or update patient information in the network database 130. As a further example, an out-of-network access device 222 may only be authorized by the authorization subsystem 250 to read certain patient information from the network database 130.

The authorization subsystem 250 may authorize access to the network database 130 based at least in part on validation of the user requesting authorization by utilizing one or more of the following: a personal identification code, an identification card, a fingerprint scanner, a retina scanner, an iris scanner, a facial recognition device, or other biometric or authentication device, system, program, or mechanism. The personal identification code may be, for example, an alphanumeric password, identifier number, or a 4-digit personal identification number (PIN). The identification card may be similar to a patient card, but may instead identify, for example, a medical administrator rather than a patient. The identification card may be similar to or include an employer's identification card.

In certain embodiments of the present invention, one or more of the systems requesting authorization, the user requesting authorization, and the patient may need to be validated to the authorization subsystem 250. When authorized by the authorization subsystem 250, the out-of-network access device 222 may communicate with the network database 130. This communication may take place through the authorization subsystem 250.

In an embodiment of the present invention, once authorized, the out-of-network access device 222 may communicate (not shown) with the network database 130 without passing through the authorization subsystem 250. For example, once authorized, the out-of-network access device 222 may be given a key, cookie, or time-limited password to access the network database 130. This communication may be similar to the communication between the access device 120 and the network database 130. That is, it may be by, for example, a phone line, Internet, computer network, a satellite, a virtual private network, wireless network, or cellular network. The communication between the access device 120 and the network database 130 may be, for example, encrypted and/or protected by a password or other authentication mechanism. That is, an out-of-network access device 222 may obtain authorization to communicate with the network database 130. Authorization may be automatically obtained, or the access device 222 may prompt a system or user for authorization, for example.

In an embodiment of the present invention, the patient card 110 may communicate with the network database 130. This communication may be similar to the communication between an access device 120 and the network database 130. For example, the communication between the patient card 110 and the network database 130 may be by a phone line, Internet, computer network, a satellite, a virtual private network, wireless network, or cellular network.

In an embodiment of the present invention, the network database 130 may contain an indicator associated with a patient file, containing, for example, medical records and patient information. For some patient card 110 implementations, a change or update made to a medical record will not be updated on the patient card 110 until the card 110 is subsequently accessed by an access device 120. For example, a medical report may be populated by a patient card 110 that has a magnetic strip when it is accessed by an access device 120. A change to the patient information in a medical report may be updated in the network database 130. For example, prescription information may be added to a patient medical report after a visit with a physician. However, this update will not be reflected on the patient card 110 until the card 110 is subsequently accessed by the access device 120. An indicator may be set on the patient file in the network database so that the next time the patient card 110 is accessed, the access device 120 will know to update the patient information stored on the patient card 110 with the updated patient information in the network database 130. In addition, subsequent attempts to modify the patient file may be blocked when the indicator is set in the network database 130 until the patient card 110 has been accessed and updated by the access device 120.

Although the above description refers to only the out-of-network console 222 communicating with the authorization subsystem 250, in certain embodiments of the present invention, an access device 120 or patient card 110 may communicate with the authorization subsystem 250. For example, an in-network access device 221 may communicate with the authorization subsystem 250. Similar to an embodiment described above regarding the out-of-network access device 222, communication by an access device 120 or patient card 110 with the network database 130 may take place after the access device 120 or patient card 110 has been authorized by the authorization subsystem 250 without further communication through the authorization subsystem 250.

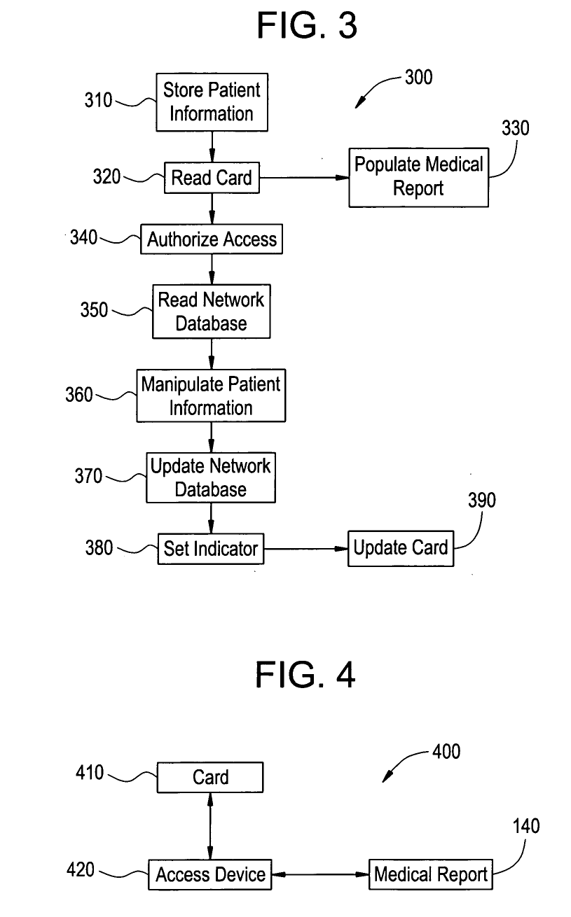

FIG. 3 illustrates a flow diagram for a method 300 for patient identification cards for efficient medical care used in accordance with an embodiment of the present invention. The method 300 includes the following steps, which will be described in more detail below. First, at step 310, patient information is stored. Next, at step 320, a patient card is read. Then, at step 330, a medical report is populated. At step 340, access to the network database is authorized. Then, at step 350, patient information is read from a network database. At step 360, patient information is manipulated. Next, at step 370, the network database is updated. At step 380, an indicator is set in the network database. Then, at step 390, the patient card is updated. Certain embodiments of the present invention may omit one or more of these steps and/or perform the steps in a different order than the order listed.

First, at step 310, patient information is stored. Storing patient information may include modifying patient information already stored. For example, the access device 120, which may be, for example, an in-network access device 221 or an out-of-network device 222, may store or update patient information on the patient card 110 and/or the network database 130.

Next, at step 320, a patient card is read. For example, an access device 120 may read patient information from the patient card 110. Information may be read from the patient card 110 by, for example, one or more of a barcode, magnetic strip, wireless communication device, portable storage device, and a smart card chip, as described above.

Then, at step 330, a medical report is populated. Populating the medical report may include modifying or updating the medical report, for example. The medical report is populated, at least in part, based on patient information read by the access device. For example, the access device 120 may populate the medical report with patient information read from the patient card 110 and/or from the network database 130.

At step 340, access to the network database is authorized. For example, the access device 120 may be authorized to access patient information in the network database 130. The authorization step may be performed, for example, by an authorization subsystem 250, as described above. Authorization may include the ability to read, write, and/or update patient information in the network database. The level of authorization may be based at least in part on the user being authorized. For example, a nurse may be authorized by the authorization subsystem 250 only to read patient information from the network database 130. As another example, a physician may be authorized by the authorization subsystem 250 to read, write, and update patient information in the network database 130.

Then, at step 350, patient information is read from the network database. For example, the access device 120 may retrieve patient information from the network database 130. Authorization may be obtained to read the network database as described above in step 340, for example.

At step 360, patient information is manipulated. Manipulating patient information may include changing the patient information and/or populating a medical report with the patient information. Manipulating patient information may also include one or more of reading, writing, and modifying the patient information. For example, the access device 120 may manipulate patient information retrieved from the patient card 110 or the network database 130. As an additional example, the patient card 110 may manipulate patient information stored in the patient card 110 or in the network database 130.

Next, at step 370, the network database is updated. Updating the network database may include writing new patient information or changing existing patient information in a medical record in the network database. The new patient information may have been read from the patient card. For example, the access device 120 may add new prescription information to a patient medical record in the network database 130. As another example, an out-of-network access device 222 may store patient information on the patient card 110, and an in-network access device 221 may read the patient information from the patient card 110 and also read patient information from the network database 130. When different patient information is stored in the patient card 110, the network database 130 may be updated, for example. In an embodiment, the network database 130 is updated with information from the patient card 110 if the information on the patient card 110 is more recent than the information stored in the database 130.

At step 380, an indicator is set in the network database. When patient information in the network database is changed, an indicator associated with the patient record may be set. When the indicator is set, the patient information stored in the patient card may be updated, or new patient information may be stored in the patient card. For example, an indicator may be set in the network database 130 if an access device 120 has updated patient information in the network database 130 but has not yet updated the patient information on the patient card 110.

Then, at step 390, the patient card is updated. Updating the patient card may include writing new patient information to the patient card or changing patient information stored on the patient card. For example, the access device 120 may update the patient card 110 with patient information retrieved from the network database 130. As another example, an out-of-network access device 222 may update patient information stored in the patient card 110.

As mentioned above, certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

In operation, for example, first, at step 320, patient information may be read from the patient card 110 by the access device 120. Next, at step 330, a medical report may be populated by the access device 120, as described above.

In an embodiment, for example, first, at step 320, card patient information may be read from the patient card 110 by the access device 120. Next, at step 350, database patient information may be read from the network database 130 by the access device 120. Then, at steps 370 and 390, patient information on one or both of the network database 130 and the patient card 110 may be updated, as described above.

FIG. 4 illustrates a system 400 for patient identification cards for efficient medical care used in accordance with an embodiment of the present invention. The system 400 includes a patient card 410, a patient card access device 420, and a medical report 140. The system also includes a data processor (not shown) in certain embodiments. The patient card 410, patient card access device 420, and medical report 140 of the system 400 may be similar to the patient card 110, patient card access device 120, and medical report 140 of the system 100, for example.

The access device 420 is capable of communication with the patient card 410. The medical report 140 is capable of communication with the access device 420 and/or the patient card 410. The data processor may be located in the patient card 410 and/or the access device 420.

In operation, the access device 420 may communicate with the patient card 410 to retrieve patient information stored in the patient card 410. In an embodiment, the patient card 410 may read, write, and/or modify the patient information stored in the patient card 410. In an embodiment, the access device 420 may read, write, and/or modify the patient information stored in the patient card 410.

The data processor may be, for example, a hardware microcontroller or processing unit, a software application or service, or a combination of hardware and software. For example, the data processor may be an embedded smart card chip located in the patient card 410. As another example, the data processor may be a software application running in the access device 420.

In an embodiment, the patient card 410 may populate the medical report 140 based in part on the patient information stored in the patient card 410. The patient card 410 may read, write, and/or modify the medical report 140. The patient card 410 may use logic rules to populate the medical report 140 when data field names differ between the patient information and the medical report 140 being populated. For example, the logic rules may be used to compare data field names, associated numeric codes, and/or other lexical attributes between the patient information and the medical report 140 being populated. A lexicon may be used to define certain patient data attributes that may be present in the patient card 410 and/or the medical report 140. In populating the medical report 140, the patient card 410 may in part utilize a data processor.

In an embodiment, the access device 420 may populate the medical report 140 based in part on the patient information stored in the patient card 410. The access device 420 may read, write, and/or modify the medical report 140. The access device 420 may use logic rules to populate the medical report 140 when data field names differ between the patient information and the medical report 140 being populated. For example, the logic rules may be used to compare data field names, associated numeric codes, and/or other lexical attributes between the patient information and the medical report 140 being populated. A lexicon may be used to define certain patient data attributes that may be present in the access device 420 and/or the medical report 140. In populating the medical report 140, the access device 420 may in part utilize a data processor.

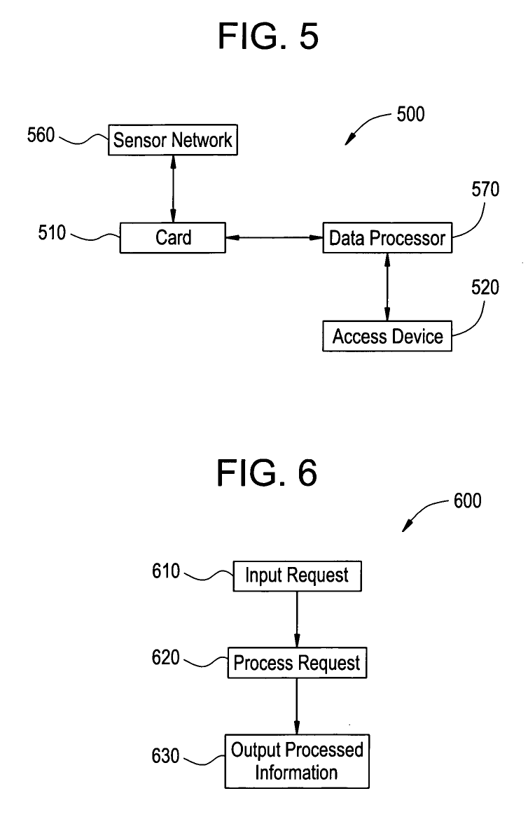

FIG. 5 illustrates a system 500 for patient identification cards for efficient medical care used in accordance with an embodiment of the present invention. The system 500 includes a patient card 510, a patient card access device 520, a sensor network 560, and a data processor 570. In an embodiment, the patient card 510 and access device 520 may be similar to the patient card 110 and patient card access device 120 of system 100.

The patient card 510 is capable of communication with the sensor network 560. The data processor 570 is capable of communication with the patient card 510 and the access device 520.

In operation, the sensor network 560 communicates patient information to the patient card 510. The patient information communicated by the sensor network 560 may be, for example, physiologic data. In an embodiment, the sensor network 560 may be connected to one or more physiologic sensors. The physiologic sensors may be implanted or in proximity to a patient. For example, the sensor network 560 may include blood flow meters placed at key vascular junctures in the brain. In an embodiment, the patient card 510 may be implanted or in proximity to a patient.

The patient card 510 may monitor, request, and/or process the patient information from the sensor network 560. The patient card 510 may include an on-board lab. The lab may, for example, perform one or more tests and/or monitor patient information from the sensor network 560. For example, the patient card 510 may perform blood tests to determine results for blood oxygen level, white blood cell count, T-cell count, complete blood count, thyroid, cardiac risk factors, cholesterol, proteins, PSA (prostate), waste products, and glucose. The patient card 510 may, for example, track the results of the blood tests and may monitor or record the patient information. For example, the patient card 510 may record the patient information from the sensor network 560 at pre-calculated intervals, look for trends in results, make a diagnostic recommendation, or generate a notification to an access device 520 when a result deviates from a normal range.

In an embodiment, the patient card 510 may evaluate patient information from the sensor network 560 in combination with the patient information stored in the patient card 510 to reach a diagnostic recommendation and, for example, notify an access device 520 or flag patient information for future examination.

In an embodiment, the data processor 570 may be located in the patient card 510 and/or the access device 520. The data processor 570 may be implemented in hardware, software, or a combination of both, as described above. In an embodiment, the lab on the patient card 510 may include the data processor 570. In an embodiment, the data processor 570 may populate a medical report based in part on the patient information stored in the patient card 510. In an embodiment, the data processor 570 may populate a medical report based in part on the patient information received from the sensor network 560. The data processor 570 may read, write, and/or modify the medical report. The data processor 570 may use logic rules to populate the medical report when data field names differ between the patient information and the medical report being populated.

FIG. 6 illustrates a flow diagram for a method 600 for obtaining patient information using a patient card. The method 600 includes the following steps, which will be described in more detail below. First, at step 610, a request is input. Next, at step 620, the request is processed. Then, at step 630, the processed information is output. Certain embodiments of the present invention may omit one or more of these steps and/or perform the steps in a different order than the order listed.

First, at step 610, a request is input. The request is made to a data processor from a patient card access device. The request may include, for example, a form to be filled out, a report to be filled out, a query for a specific piece of patient information, or a set of rules for the data processor to use for future notifications. For example, an access device 120 may input a request for a specific piece of patient information to a data processor 570.

Next, at step 620, the request is processed. A data processor processes the request based in part on patient information stored in a patient card. For example, a data processor 570 may fill out a medical report 140 based in part on patient information stored in a patient card 110 when a request to fill out a medical report is inputted by an access device 120, such as in step 610.

Then, at step 630, the processed information is output. A data processor outputs the processed information. The processed information may be output to, for example, a structured report or data entry, a notification, or data storage. To continue the previous example, a data processor 570 may output the medical report 140 that was filled out using the stored patient information in response to the request inputted by the access device 120.

As mentioned above, certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

Thus, certain embodiments of the present invention provide the convenience of not having to manually enter patient information multiple times and improving hospital workflow and patient throughput. Certain embodiments also greatly reduce the potential for one or both of data entry errors and patient omission errors. Certain embodiments of the present invention allow the integration of patient information from multiple sources, keeping the patient's medical records up to date. Certain embodiments of the present invention also provide notification of changes to patient information.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. An improved patient identification card system for efficient medical care, said system including:
a patient card, said patient card capable of storing patient information, said patient card including a data processor;
a patient card access device, said patient card access device capable of communicating with said patient card; and
a medical report, said medical report capable of being in communication with at least one of said patient card and said patient card access device.

2. The system of claim 1, wherein said patient card is capable of at least one of reading, writing, and modifying said patient information.

3. The system of claim 1, wherein said patient card populates said medical report based in part on said patient information.

4. The system of claim 3, wherein said patient card is capable of populating said medical report using logic rules to resolve discrepancies in data field names.

5. An improved patient identification card system for efficient medical care, said system including:
a patient card, said patient card capable of storing patient information;
a patient card access device, said patient card access device capable of communicating with said patient card, wherein said patient card access device includes a data processor;
and a medical report, said medical report capable of being in communication with at least one of said patient card and said patient card access device.

6. The system of claim 5, wherein said patient card access device is capable of at least one of reading, writing, and modifying said patient information.

7. The system of claim 5, wherein said patient card access device populates said medical report based in part on said patient information.

8. The system of claim 7, wherein said patient card access device is capable of populating said medical report using logic rules to resolve discrepancies in data field names.

9. An improved patient identification card system for efficient medical care, said system including:
a patient card, said patient card capable of storing and communicating patient information;
a physiologic sensor network, said physiologic sensor network capable of communicating with said patient card;
a patient card access device, said patient card access device capable of communicating with said patient card; and
a data processor, said data processor capable of communicating with at least one of said patient card and said patient card access device.

10. The system of claim 9, wherein said patient card is implanted.

11. The system of claim 9, wherein said patient card stores physiologic data communicated by said physiologic sensor network.

12. The system of claim 11, wherein said data processor notifies said patient card access device based in part on said physiologic data.

13. The system of claim 11, wherein said data processor makes a diagnostic recommendation based in part on said physiologic data.

14. The system of claim 9, wherein said patient card includes said data processor.

15. The system of claim 9, wherein said patient card access device includes said data processor.

16. The system of claim 9, wherein said data processor populates a medical report based in part on said patient information.

17. The system of claim 16, wherein said data processor is capable of populating said medical report using logic rules to resolve discrepancies in data field names.

18. A method for obtaining patient information using a patient card, said method including:
inputting a request to a data processor from a patient card access device;
processing said request using said data processor based in part on patient information stored in a patient card; and
outputting processed information from said data processor to a medical report.

19. The method of claim 18, further comprising transferring said patient information between said patient card and a database.

20. The method of claim 18, further comprising authorizing access to modify said medical report.
